(19) United States
(12) Patent Application Publication
(10) Pub. No.: US 2015/0219013 A1
(43) Pub. Date: Aug. 6, 2015

(54) AIRCRAFT TURBOMACHINE ASSEMBLY WITH REDUCED JET NOISE

(71) Applicant: Airbus Operations (SAS), Toulouse (FR)

(72) Inventors: Jerome Huber, Toulouse (FR); Arnaud Hormiere, Toulouse (FR); Lois Dussol, Toulouse (FR); Clemence Barthomeuf, Blagnac (FR); Au Dax, Colomiers (FR); Florent Bonneau, Colomiers (FR)

(21) Appl. No.: 14/336,089

(22) Filed: Jul. 21, 2014

(30) Foreign Application Priority Data
Jul. 26, 2013 (FR) 1357373

(51) Int. Cl. F02C 7/24; F02C 3/04

(52) U.S. Cl. CPC F02C 7/24; F02C 3/04

(57) ABSTRACT

A turbomachine assembly comprising a device that attenuates noise by ejecting jets of fluid, this device comprising fluid supply ducts, fluid ejection tubes and a distribution duct of annular shape. The distribution duct is connected firstly to inlets of the ejection tubes and secondly to outlets of the fluid supply ducts so as to create a flow path for the circulation of fluid from the inlets of the fluid supply ducts to the outlets of the ejection tubes.

### CROSS-REFERENCES TO RELATED APPLICATIONS

This application claims the benefit of the French patent application No. 1357373 filed on Jul. 26, 2013, the entire disclosures of which are incorporated herein by way of reference.

### BACKGROUND OF THE INVENTION

The present invention relates to a turbomachine assembly with reduced jet noise which is intended to be fitted to an aircraft, particularly a transport airplane.

In the known way, an aircraft turbomachine assembly comprises a nacelle inside which is installed a turbomachine comprising a gas generator which drives a fan. This nacelle is generally mounted under the wing structure of the aircraft via a pylon. Although not exclusively, the present invention applies more particularly to a bypass turbojet engine.

The stream of air which passes longitudinally through the nacelle partly enters the gas generator and contributes to combustion. This part of the stream, referred to as the primary stream, is ejected at the outlet of the generator.

That part of the air stream that enters the nacelle but does not pass through the gas generator, referred to as the bypass stream, flows along an annular passage, concentrically with respect to the primary stream and driven by the fan. This annular passage is formed between an external longitudinal wall (nacelle wall) and an internal longitudinal wall surrounding the gas generator. The bypass stream is ejected from the nacelle at the downstream end of the external wall thereof. The internal wall surrounding the gas generator also defines, with an internal longitudinal component, an annular passage along which the primary stream flows. The primary stream is ejected at the downstream end of the internal wall which surrounds the gas generator.

During takeoff phases, the stream of gas that is ejected (the primary stream and bypass stream) is at very high speed. At such speeds, the action of the ejected stream encountering the surrounding air, and the action of the primary stream meeting the bypass stream, generate a great deal of noise.

In order to reduce this type of noise, it is known practice to generate turbulence in the region in which the streams meet, particularly using chevrons made on the trailing edge of the walls. These chevrons do, however, generate drag, particularly in situations for which noise reduction is not needed, such as during cruising flight.

In order to remedy this disadvantage, noise attenuating devices that allow the noise to be reduced without increasing the drag unlike the usual chevrons are known, notably from patents FR-2 892 152 and U.S. Pat. No. 8,096,105 on the one hand, and patents FR-2 929 337 and U.S. Pat. No. 8,393,139 on the other. These devices, mounted on at least one wall of an aircraft turbomachine assembly, bleed fluid from one stream (primary stream or bypass stream) of the turbomachine and inject jets of fluid into the stream (primary stream or bypass stream) ejected by the turbomachine, in order to create turbulence in the manner of chevrons.

In order to obtain an effective noise reduction, the jets of fluid injected at the outlet of the device need to be precisely controlled in terms of the fluidic properties thereof: pressure and mass flow rate (namely in terms of the quantity of fluid, expressed as a mass, flowing through a given flow section over a unit time).

Therefore, the air intakes of the device need to supply a certain mass flow rate to the entire device with a given compression ratio at the outlet, so as to supply all the outlets the number of which is defined by acoustic considerations.

Now, the fluidic properties of the jets of fluid are dependent on any pressure drops that may be induced by additional systems and ducts intended to convey the fluid to these outlets.

The jet engine noise reduction device is therefore dependent on the correct operation of the fluid inlets and means of transmitting and regulating the fluid, and its performance may be deteriorated if there is a malfunctioning of these elements.

### SUMMARY OF THE INVENTION

It is an object of the present invention to overcome the abovementioned disadvantage. The invention relates to an aircraft turbomachine assembly comprising at least one wall centered around a longitudinal axis of the turbomachine assembly, the wall comprising a first face surrounding a stream of gas which is ejected at a downstream end of the wall, the turbomachine assembly comprising at least one noise attenuation device, said device comprising a plurality of ejection tubes distributed at the periphery of the downstream end of the wall, said ejection tubes comprising, along the longitudinal axis, a first end and a second end and being able to eject at their second end jets of fluid which are intended to interact with the ejected gas stream.

According to the invention, the said device for attenuating the noise of the turbomachine assembly additionally comprises:
a fluid supply duct comprising, along the longitudinal axis, a fluid inlet arranged at the level of the first face of the wall and a fluid outlet; and
a distribution duct, the distribution duct being of annular shape, being arranged at the level of said wall, extending transversely to the longitudinal axis and being connected by a fluidic connection firstly to the first end of said ejection tubes and secondly to the fluid outlet of the at least one fluid supply duct so as to create a flow path along which fluid can circulate from the fluid inlet of the at least one fluid supply duct to the second end of the ejection tubes via, in succession, said at least one fluid supply duct, said distribution duct and said ejection tubes.

Thus, by virtue of the invention, the device for attenuating the noise of the turbomachine assembly comprises an annular distribution duct which connects together all the inlets and all the outlets so that the fluid bled from the inlets is conveyed to the distribution duct before being distributed to the ejection tubes and ejected at the outlets thereof. Thus, the turbomachine assembly can use a number of inlets which is different from the number of outlets and the performance of this turbomachine is not impaired (or at worst is impaired only to a very limited extent) if one fluid inlet is at least partially defective (non-operational), making it possible to overcome the aforementioned disadvantage.

Within the context of the present invention, a fluidic connection means a coupling or connection between two elements through which fluid circulates, notably ducts and tubes, that allows fluid circulating in a first of said elements to be transmitted to the second of said elements.

In a first embodiment, at least one fluid supply duct comprises a duct of constant cross section. Furthermore, in a second embodiment, at least one fluid supply duct comprises a duct of a cross section that increases in a direction of flow of fluid through the turbomachine assembly.

Moreover, in one preferred embodiment, said distribution duct corresponds to a continuous annulus forming a closed curve and being fixed to the wall transversely to the longitudinal axis, said continuous annulus allowing fluid to circulate along the entire closed curve. However, in one particular embodiment, said distribution duct may comprise a limited number of separate annulus portions, the annulus portions being fixed to the wall and being arranged in succession in the continuation of one another along the periphery of the wall transversely to the longitudinal axis.

Furthermore, in one particular embodiment, said distribution duct is arranged in such a way as to surround a second face of said wall. However, in a preferred embodiment, said distribution duct is arranged between the first face and a second face of said wall.

The present invention also relates to an aircraft, particularly a transport airplane, which comprises at least one turbomachine assembly as described hereinabove.

### BRIEF DESCRIPTION OF THE DRAWINGS

The figures of the attached drawing will make it easy to understand how the invention may be embodied. In these figures, identical references denote similar elements.

FIG. 1 is a schematic overall view in longitudinal section of one example of an aircraft turbomachine assembly to which the invention may apply.

FIGS. 2 and 3 are schematic perspective views of a wall comprising a device illustrating the invention and provided, respectively, with a continuous annular duct and with an annular duct made up of distinct portions.

FIGS. 4 and 5 are schematic views in longitudinal section illustrating two different layouts of an annular duct in a wall.

### DETAILED DESCRIPTION OF THE PREFERRED EMBODIMENTS

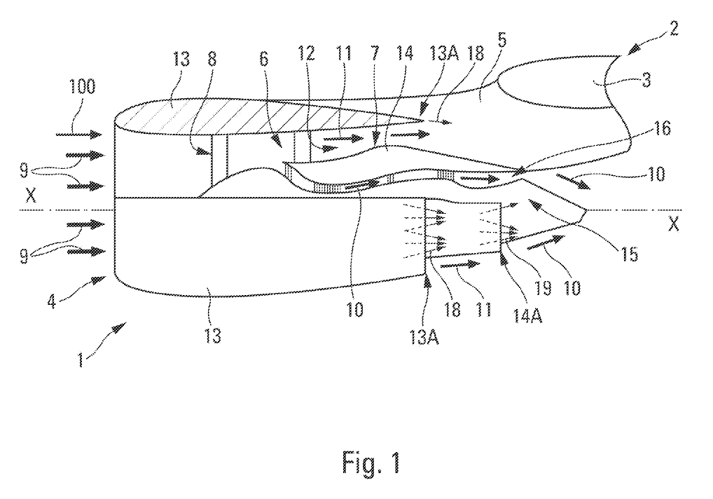

The present invention relates to a turbomachine assembly 1 of an aircraft 2, particularly a transport airplane, only part of a wing 3 of which has been depicted in FIG. 1.

Throughout the description the terms “upstream” and “downstream” are defined with respect to the direction in which the streams of fluid flow throughout the turbomachine 1, this direction being indicated schematically by an arrow 100 in the figures.

In the usual way, an aircraft turbomachine assembly 1 comprises a nacelle 4 which is generally mounted under a wing 3 of the aircraft 2 via a pylon 5. This nacelle 4 has symmetry of revolution about a longitudinal axis X-X and surrounds a turbomachine 6, particularly a bypass turbojet engine, as schematically indicated in FIG. 1.

The turbomachine 6 comprises a central gas generator 7 which drives a fan 8 mounted on the shaft of the generator 7, upstream of the latter in the longitudinal direction of the nacelle 4. This generator 4 in the usual way comprises low-pressure and high-pressure compressors, a combustion chamber and low-pressure and high-pressure turbines.

Part of the air stream 9 entering the nacelle 4 passes longitudinally through it, enters the generator 7, participates in combustion and is ejected at the outlet of the generator 7. This part of the ejected air stream is referred to as the primary stream 10.

That part of the air stream 9 that enters the nacelle 4 but does not pass through the generator 7 is referred to as the bypass stream 11 and flows, driven by the fan 8, along an annular passage 12 arranged concentrically with respect to the generator 7. This annular passage 12 is formed between an external longitudinal wall 13 (the cowl of the nacelle 4) and an internal longitudinal wall 14 (the cowl of the generator 7) surrounding said generator 7. The bypass stream 11 (or cold propulsion stream) is ejected from the nacelle 4 at the downstream end 13A of the external wall 13, substantially in the longitudinal direction of the turbomachine assembly 1.

Furthermore, the internal longitudinal wall 14 forms, with a central longitudinal part 15 that constitutes the heart of the turbomachine assembly 1, an annular passage 16 through which the primary stream 10 (or hot propulsion stream) flows and is ejected at the downstream end 14A of the internal wall 14.

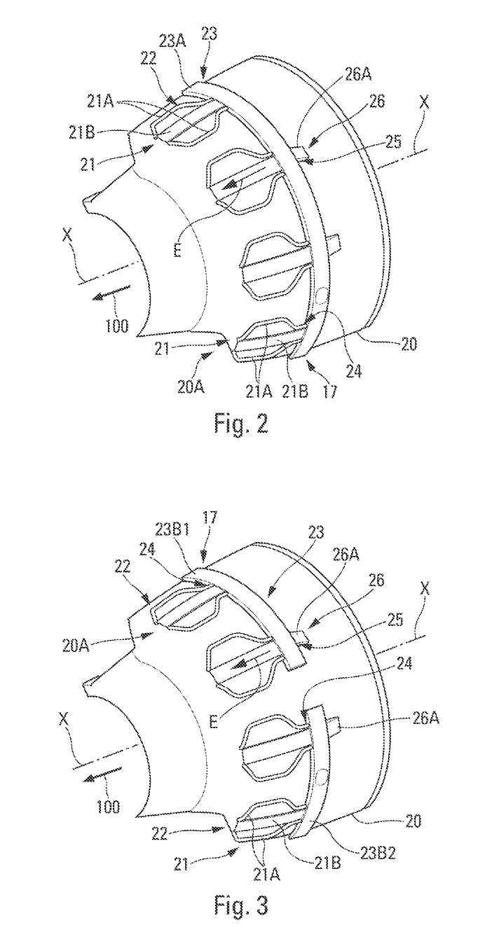

Said turbomachine assembly 1 additionally comprises at least one device 17 (not depicted in FIG. 1 but depicted in FIGS. 2 to 5) intended to attenuate the noise level of the turbomachine assembly 1, by producing jets of fluid.

This device 17 is, for example, positioned at the level of the external wall 13 (outer cowl) of the nacelle 4 which surrounds the annular passage 12 via which the bypass stream 11 is ejected so as to eject jets of fluid 18 (FIG. 1) at the downstream end 13A of the external wall 13, which jets will interact with the ejected bypass stream 11 so as to reduce the noise generated by the latter. Similarly, the device 17 may also be arranged at the level of the internal wall 14 (internal cowl) of the nacelle 4, which surrounds the annular passage 16 via which the primary stream 10 is ejected so as to eject jets of fluid 19 (FIG. 1) at the downstream end 14A of the internal wall 14, which jets will interact with the ejected primary stream 10 in order to reduce the noise generated by the latter. Such a device 17 may be provided at the level of each of said concentric walls 13 and 14. The noise attenuation device 17 is thus able, on demand, to generate a disturbance in the flow immediately downstream of the downstream end 13A, 14A of the wall 13, 14 at the level of the (primary or bypass) stream ejected at this end.

In the schematic example of FIGS. 2 and 3, the device 17 is arranged at the level of a wall 20. The embodiment set out in these FIGS. 2 and 3 may be provided at one and/or the other of the two concentric walls 13 and 14 (external and internal cowls) of the turbomachine assembly 1 of FIG. 1.

The device 17 can be operated as described hereinbelow. It is essentially intended for the takeoff phase and is notably inactive during the phase when the aircraft 2 is cruising.

Said device 17 comprises, as depicted in FIGS. 2 and 3, a plurality of ejection tubes 21 which are distributed at the periphery of the downstream end 20A of the wall 20. These ejection tubes 21 are able to eject, at this gas stream (primary stream or bypass stream) downstream outlet end 20A, jets of fluid which are intended to interact with this ejected stream of gas.

In the particular embodiment of FIGS. 2 and 3, the device 17 comprises eight ejection tube 21 assemblies 22 (just four of which have been depicted in FIGS. 2 and 3), uniformly distributed about the periphery of the wall 20. Each of said assemblies 22 comprises three ejection tubes and more specifically:
a pair of ejection tubes 21A, of small circular cross section, each able to eject a microjet; and
one ejection tube 21B, of rectangular cross section, which is larger than the cross section of the ejection tubes 21A. This ejection tube 21B is positioned between the ejection tubes 21A of the associated pair and is able to eject a greater jet of fluid, of substantially planar shape.

The ejection tubes 21A and 21B of one and the same set 22 are oriented in such a way that the jets generated converge more or less toward one and the same point, as illustrated by the arrows 18 and 19 in FIG. 1. This then creates a fluidic zone which is almost impermeable to the ejected gas stream, making it possible to obtain effective noise reduction.

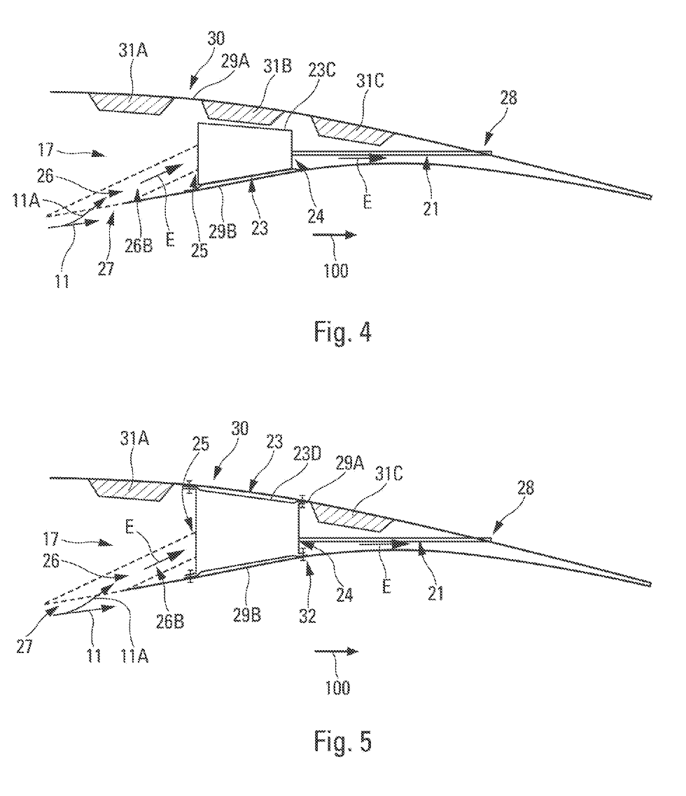

According to the invention, said device 17 additionally comprises fluid supply ducts 26 each comprising, along the longitudinal axis X-X, an inlet 27 (FIGS. 4 and 5) and an outlet 25, as well as a distribution duct 23, of annular shape, arranged at the level of said wall 20 transversely to the longitudinal axis X-X.

Said distribution duct 23 is connected (by fluidic connection):
firstly to the inlets 24 of said ejection tubes 21 at the upstream end thereof (in the direction E in which the fluids flow through the device 17); and
secondly to the outlets 25 of the supply ducts 26 so as to create a flow path for the circulation of fluid from the inlets 27 (FIGS. 4 and 5) of the supply ducts 26 as far as the outlets 28 (FIGS. 4 and 5) of the ejection tubes 21 via, in succession, said supply ducts 26, said distribution duct 23 and said ejection tubes 21.

The inlets 27 of the supply ducts 26 are arranged on that face of the wall that is swept by the flow of the stream, from which fluid is to be bled, for example on the face 29B of the wall 30 in the examples of FIGS. 4 and 5. The inlets 27 may be provided flush with said wall 30, as illustrated in FIGS. 4 and 5. They may equally project from the face of the wall that is swept by the flow of the stream. The inlets 27 allow part of this stream, for example a proportion 11A of the stream 11, to be bled off as indicated in FIGS. 4 and 5.

The device 17 therefore comprises a distribution duct 23 which connects together all the inlets and all the outlets so that the fluid bled from the inlets 27 (provided in a flow of fluid of the turbomachine assembly 1) is conveyed to the distribution duct 23 before being distributed to the ejection tubes 21 and thus ejected at the outlets 28 thereof (at the downstream ends thereof). Thus, the device 17 is, for example, provided with a number of supply ducts 26 which differs from the number of ejection tubes 21 or assemblies 22, and its performance is not impaired (or at worst is so only to a very limited extent) if a supply duct 26 is at least partially defective (or non-operational), particularly by becoming (partially or completely) obstructed, for example at the inlet 27 thereof.

The device 17 is therefore able to provide fluid (air), bled throughout the turbomachine 1, to the outlet of the ejection tubes 21 according to the air flow conditions, such as the mass flow rate and pressure, and the number of ejection tubes 21 required for acoustic considerations.

In a preferred embodiment, depicted in FIG. 2, said distribution duct 23 corresponds to a continuous hollow annulus 23A allowing fluid to circulate along the entire closed curve forming this annulus 23A, namely around the entire periphery of the wall 20. This preferred embodiment allows all the supply ducts 26 and all the ejection tubes 21 of the device 17 to be connected together, making it possible to optimize the aforementioned features and advantages of the invention.

Furthermore, in one particular embodiment, as depicted in FIG. 3, said distribution duct 23 may comprise a (limited) number of separate hollow annulus portions 23B 1, 23B2, for example two or three portions, which are arranged in succession in the continuation of one another along the periphery of the wall 20 transversely to the longitudinal axis X-X. This embodiment allows the distribution duct 23 (which is not fully continuous) to be adapted to suit the configuration of the wall for which it is intended, for example by spitting it into two portions, particularly when it is provided in the external wall 13 (the external cowl of the nacelle 4), notably to allow the nacelle 4 to be suspended and to allow the cowl hatches to be opened.

Moreover, in a first embodiment, each of said supply ducts 26 comprises a duct 26A (or diffuser) which has a cross section that increases in the direction of flow of the fluid, as indicated schematically in FIGS. 2 and 3. Furthermore, in a second embodiment, each of said supply ducts 26 comprises a duct 26B which has a constant cross section, as indicated schematically in FIGS. 4 and 5. The choice between these two embodiments can be made notably according to the mass flow rate required and the space available.

In one particular embodiment, said supply ducts 26 which are able to bleed fluid flowing through the nacelle 4 may be arranged at the fan 8 of the turbomachine assembly 1, this representing a good compromise between performance and installation considerations, the flow having a high mass flow rate and a low compression ratio. Said supply ducts 26 may also be arranged in the compression zone of the generator 7 of the turbomachine assembly 1.

In one particular embodiment, said device 1 may be incorporated, with limited modifications, into the secondary flow path of a thrust reverser of the turbomachine assembly 1.

The device 17 thus allows the fluid (air) bled from the turbomachine assembly 1 (from the fan 8 or from the compression zone in particular) to be distributed, with a suitable number of fluid inlets 27, to various ejection tubes 21 (of suitable shape and in suitable number), thereby reducing pressure drops and ensuring the mass flow rate and flow pressure that are needed throughout the device 17. The size and shape of the annular duct 23 may be adapted to suit the envisioned layout.

In addition, the device 17 may be arranged with limited modifications to the structure and allocation of existing space and has a limited impact on performance (such as pressure drops).

In one particular embodiment, said distribution duct 23 of the device 17 is arranged in such a way as to surround a face (external or internal) of the wall at the level of which it is provided.

However, in a preferred embodiment, said distribution duct 23 is arranged inside a wall 30 delimited by faces 29A and 29B, as indicated very schematically by embodiments 23C and 23D in FIGS. 4 and 5.

In the example of FIG. 4, the distribution duct 23C, produced for example in the form of an annular casing, is fixed to the internal side (i.e. on the inside of the wall 30) of the internal face 29B. The wall 30 also comprises, on the internal side (namely on the inside of the wall 30) of its external face 29A, the usual stiffeners 31A, 31B and 31C.

In one particular alternative form of this preferred embodiment, which is indicated in FIG. 5, said distribution duct 23D is configured to constitute a structural reinforcing element of the wall 30. It is, for example, produced in the form of a casing 29B, having a suitable rigidity, which is fixed by the usual fixing means 32 simultaneously to the opposite internal sides of the faces 29A and 29B of the wall 30.

Thus, with suitable adjustment, the annular duct 23D can be used as a structural part and replace stiffeners, particularly the stiffener 31B of FIG. 4 in the example of FIG. 5. When such is the case, the annular duct 23D is used for acoustic purposes (to reduce the noise from the device 17 comprising this annular duct 23D) and also as a structural part.

In addition, as the environment surrounding the nacelle 4 is very restricted regarding the space available in which to integrate new systems, the device 17 has the advantage that it can be installed with reduced modifications to the nacelle 4.

The operation of the device 17 for reducing the noise level of the turbomachine assembly 1, as described hereinabove, which is activated during the takeoff phase of the aircraft 2, is as follows:
fluid is bled by the supply ducts 26, the inlets 27 of which are arranged at the level of a flow of fluid (notably of air) of the turbomachine assembly 1 (for example near the fan 8 or in a compression zone);
the fluid is conveyed by the supply ducts 26 to the distribution ducts 23;
the latter distributes this fluid to the various ejection tubes 21 which eject it at the outlets 28 thereof. These outlets 28 are provided at the level of the ejection of a stream of gas (which generates noise) in order to create interactions with this stream that allow the noise to be attenuated.

Activation and deactivation of the device 17 is handled electronically by a central unit which operates actuators that allow the inlets 27 to the supply ducts 26 to be opened (for activation) or closed off (for deactivation).

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft turbomachine assembly comprising:
at least one wall centered around a longitudinal axis of the turbomachine assembly,
the wall comprising a first face surrounding a stream of gas which is ejected at a downstream end of the wall,
at least one noise attenuation device,
said device comprising a plurality of ejection tubes distributed at the periphery of the downstream end of the wall,
said ejection tubes comprising, along the longitudinal axis, a first end and a second end and being able to eject at their second end jets of fluid which are intended to interact with the ejected gas stream,
the noise attenuation device additionally comprising:
a fluid supply duct comprising, along the longitudinal axis, a fluid inlet arranged at the level of the first face of the wall and a fluid outlet; and
a distribution duct, the distribution duct being of annular shape, being arranged at the level of said wall, extending transversely to the longitudinal axis and being connected by a fluidic connection firstly to the first end of said ejection tubes and secondly to the fluid outlet of the at least one fluid supply duct so as to create a flow path along which fluid can circulate from the fluid inlet of the at least one fluid supply duct to the second end of the ejection tubes via, in succession, said at least one fluid supply duct, said distribution duct and said ejection tubes;
wherein at least one fluid supply duct comprises a duct of a cross section that increases in a direction of flow of fluid through the turbomachine assembly.

2. The turbomachine assembly as claimed in claim 1, wherein said distribution duct corresponds to a continuous annulus, the continuous annulus forming a closed curve and being fixed to the wall transversely to the longitudinal axis.

3. The turbomachine assembly as claimed in claim 1, wherein said distribution duct comprises several separate annulus portions, the annulus portions being fixed to the wall and being arranged in succession in the continuation of one another along the periphery of the wall transversely to the longitudinal axis.

4. The turbomachine assembly as claimed in claim 1, wherein said distribution duct is arranged in such a way as to surround a second face of said wall.

5. The turbomachine assembly as claimed in claim 1, wherein said distribution duct is arranged between the first face and a second face of said wall.

6. An aircraft comprising at least one turbomachine assembly comprising:
at least one wall centered around a longitudinal axis of the turbomachine assembly,
the wall comprising a first face surrounding a stream of gas which is ejected at a downstream end of the wall,
at least one noise attenuation device,
said device comprising a plurality of ejection tubes distributed at the periphery of the downstream end of the wall,
said ejection tubes comprising, along the longitudinal axis, a first end and a second end and being able to eject at their second end jets of fluid which are intended to interact with the ejected gas stream,
the noise attenuation device additionally comprising:
a fluid supply duct comprising, along the longitudinal axis, a fluid inlet arranged at the level of the first face of the wall and a fluid outlet; and
a distribution duct, the distribution duct being of annular shape, being arranged at the level of said wall, extending transversely to the longitudinal axis and being connected by a fluidic connection firstly to the first end of said ejection tubes and secondly to the fluid outlet of the at least one fluid supply duct so as to create a flow path along which fluid can circulate from the fluid inlet of the at least one fluid supply duct to the second end of the ejection tubes via, in succession, said at least one fluid supply duct, said distribution duct and said ejection tubes;
wherein at least one fluid supply duct comprises a duct of a cross section that increases in a direction of flow of fluid through the turbomachine assembly.
